(19) United States
(12) Patent Application Publication
(10) Pub. No.: US 2003/0173011 A1
(43) Pub. Date: Sep. 18, 2003

(54) Pneumatic safety tire

(76) Inventors: Toru Tsuda, Tokyo (JP); Koya Tagawa, Tokyo (JP); Daisuke Maehara, Tokyo (JP); Tomohisa Nishikawa, Tokyo (JP)

Correspondence Address: SUGHRUE MION, PLLC, 2100 PENNSYLVANIA AVENUE, N.W., WASHINGTON, DC, 20037, US

(21) Appl. No.: 10/182,444

(22) PCT Filed: Nov. 27, 2001
(86) PCT No.: PCT/JP01/10339

(30) Foreign Application Priority Data
Nov. 27, 2000 (JP) 2000-358956

(51) Int. Cl. B60C 11/13; B60C 3/00; B60C 17/00; B60C 9/18; B60C 9/20; B60C 9/22

(52) U.S. Cl. 152/209.26; 152/517; 152/538; 152/454; 152/531

(57) ABSTRACT

It is to provide a pneumatic safety tire capable of continuing safe running even if an internal tire pressure drops to an atmospheric pressure and easily producing the tire, in which a side reinforcing rubber layer having substantially a crescent form at a section in a widthwise direction is mainly arranged on the sidewall portion and at least one annular depression convexly protruding inward in the radial direction and continuously extending in the circumferential direction is arranged on the belt.

### TECHNICAL FIELD

This invention relates to a pneumatic safety tire capable of continuing safe running even if an internal pressure of a tire drops to an atmospheric pressure, and particularly it proposes a pneumatic safety tire in which a thickness of a side reinforcing rubber layer can be decreased without troubles in the production and there is not feared a degradation of durability due to the concentration of strain in an inside of a tire tread portion and the weight is light and the ride comfort is excellent.

### BACKGROUND ART

As this type of the conventional pneumatic safety tire, there are tires wherein a sidewall portion 112 extending inward in a radial direction is continuously arranged on each side part of a tread portion 111 and a bead portion 113 is continuously arranged on a radially inner end of the sidewall portion 112 and a carcass 115 forming a skeleton structure of the tire is toroidally extended between the bead portions 113 and hence bead cores 114 embedded in the respective bead portions 113, and a belt 116 is arranged between a crown portion of the carcass 115 and the tread portion 111 to reinforce the tread portion 111 and a reinforcing rubber layer 117 for the sidewall portion having substantially a crescent form at a section is mainly arranged on an inner face of the sidewall portion 112 as shown, for example, by a sectional view in FIG. 1.

Moreover, the whole of the belt 116 may be covered with a belt reinforcing layer 118 having a spirally winding structure of a chemical fiber cord extending substantially in a circumferential direction, if necessary.

In this safety tire, when an internal tire pressure is leaked out by puncture or the like, a load can be supported by a flexural rigidity of the sidewall portion 112 based on the action of the side reinforcing rubber layer 117 under a relatively small crushed deformation of the tire, so that safe running can be continued over a significant distance even in the puncture of the tire or the like.

As the other conventional safety tire, JP-A-8-244422 discloses a tire wherein a small-size bead ring extending inward from the belt in the radial direction is fitted onto an outer circumference of the carcass in addition to the arrangement of the side reinforcing rubber layer as mentioned above. In this case, the load is supported by the side reinforcing rubber layer and the bead ring in the puncture of the tire or the like.

In the former technique shown in FIG. 1, however, it is unavoidable to thicken the thickness of the side reinforcing rubber layer for ensuring a high durability in the puncture of the tire or the like, so that it is obliged to increase the tire weight and also there is a problem that the ride comfort on a vehicle lowers during the running of the tire under loading at a state of filling an internal pressure.

On the other hand, in the latter technique, there is a merit that the thickness of the side reinforcing rubber layer can be decreased as compared with the above case because the side reinforcing rubber layer and the bead ring contribute to support the load, but it is unavoidable to increase the number of working steps by separately arranging the bead ring on the outer circumferential side of the carcass in the production process of the tire and also there are problems that it is difficult to set the fitting and positioning of the bead ring onto the outer circumference of the carcass and it is obliged to increase the tire weight by the bead ring.

Furthermore, when a product tire is normally run under loading, the bead ring produces a large stepwise difference of rigidity in a widthwise direction of the tread portion and the concentration of strain is caused around the bead ring, so that premature damage is generated in the tread portion by repeatedly rotating the tire under loading to degrade the durability and also there is a problem that the ground contacting area of the tread portion, directly the contacting length of the tread surface is decreased under the restraint of the bead ring having a higher rigidity to degrade the steering stability. In addition, there are problems that since the bead ring enhances the bending or flexing rigidity of the tread portion, the enveloping property of the tread portion is degraded to increase impact vibration in the riding on a large protrusion to thereby degrade the ride comfort, and a large impact force or the like is input to the tread portion and hence the high-rigidity bead ring to cause permanent deformation of the bead ring to thereby damage a degree of true circle in the tire.

These problems become serious because a time of normally running the tire under loading is considerably longer than a time of running under loading at the occurrence of troubles such as puncture of tire and the like.

It is, therefore, an object of the invention to provide a pneumatic safety tire wherein a function inherent to the safety tire capable of continuing safe running even if the internal tire pressure drops to an atmospheric pressure can be sufficiently developed even when the thickness of the side reinforcing rubber layer is decreased and also excellent durability, steering stability and ride comfort can be obtained in the normal running of the tire under loading and also the production is easy without damaging the degree of true circle and requiring special working steps.

### DISCLOSURE OF THE INVENTION

The pneumatic safety tire according to the invention comprises a tread portion, a sidewall portion extending inward from each side part of the tread portion in a radial direction, a bead portion continuously arranged at a radially inner end of the sidewall portion, a carcass toroidally extending between the pair of bead portions and frequently wound around a bead core embedded in the respective bead portion from an inside toward an outside, and a belt disposed between a crown portion of the carcass and the tread portion, in which a side reinforcing rubber layer having substantially a crescent form at a section in a widthwise direction is mainly arranged on the sidewall portion and at the same time at least one annular depression convexly protruding inward in the radial direction and continuously extending in the circumferential direction is arranged on the belt.

In this tire, the annular depression arranged on the belt serves as a reinforcing rib against crushed deformation of the tire due to leak-out of the internal pressure resulted from the puncture or the like and effectively contributes to support a load, so that the function inherent to the safety tire can be sufficiently developed even when the thickness of the side reinforcing rubber layer is decreased.

In the invention, therefore, the weight reduction of the tire can effectively be attained.

And also, the annular depression of the tire can be formed at a curing process for forming through a curing mold provided on its inner peripheral face with an annular protrusion and it is useless to conduct a special work for the formation of the annular depression at a tire building process, so that all of problems in the production of the tire can be removed.

The annular depression arranged on the belt of the safety tire has a degree of freedom in the deformation, so that the concentration of strain in the vicinity of the annular depression can effectively be mitigated by the deformation of the annular depression itself in the normal running of the tire under loading through the annular depression brings about the somewhat increase of rigidity in the widthwise direction of the tread portion and hence there is no fear of damaging the running durability. And also, the annular depression does not largely restrain the ground contacting length of the tread portion based on the deformation of the annular depression itself as compared with the high-rigidity bead ring, so that the sufficiently large ground contacting area can be always and surely guaranteed to provide an excellent steering stability.

Furthermore, the deformation of the annular depression in the belt in a direction enlarging an opening port of the depression enhances the degree of freedom in the bending or flexing deformation of the tread portion in the riding of the tire over the protrusion, so that the ride comfort of the tire against vibration can effectively be improved while sufficiently ensuring the thickness of the side reinforcing rubber layer, and further the lowering of a true circle degree in the tire can sufficiently be prevented based on the deformation of the annular depression in the belt against input such as a large external impact force or the like.

Moreover, when one or more annular depressions are arranged symmetrically with respect to a center line in the widthwise direction of the belt, a locally large deformation can effectively be prevented taking a deformation balance in the crushed deformation due to the puncture of the tire or the like.

Also, when the annular depression is arranged in a central region in the widthwise direction of the belt, the drainage performance can advantageously be improved in connection with a circumferential groove as mentioned later in addition to the aforementioned effect.

On the other hand, when a maximum thickness of the side reinforcing rubber layer as measured on a normal line drawn to a carcass line is within a range of 2-12 mm, the reduction of the rolling resistance, the further improvement of the ride comfort and the like can be attained during the normal running of the tire while sufficiently reducing the weight of the tire.

In this case, when the maximum thickness is less than 2 mm, there is a fear of too decreasing the ability of the side reinforcing rubber layer supporting the load, while when it exceeds 12 mm, the practical effect of reducing the weight or the like is poor.

In such a tire, when a main circumferential groove is arranged in the tread portion at a position corresponding to the annular depression, the drainage performance can be advantageously improved. Such a drainage performance is further improved when a total groove width of the circumferential groove(s) is not less than 10% of a ground contacting width of the tread.

Preferably, when the tire is assembled onto a standard rim defined in JATMA YEAR BOOK, ETRTO STANDARD MANUAL, TRA (THE TIRE and RIM ASSOCIATION INC.) YEAR BOOK or the like and inflated under an internal pressure of 50 kPa or is at a posture state of filling an internal pressure to an extent that local deformation is not intentionally caused in the tire assembled on the rim, a radius of an inner circumferential face of the annular depression in the belt is made smaller by 5 mm or more than a maximum radius of an inner circumferential face of the belt.

In this case, the load supporting function inherent to the annular depression or the like can sufficiently be developed in the puncture of the tire or the like to further effectively prevent an extra deformation in the radial direction on the circumference of the belt.

More preferably, a belt reinforcing layer having a spiral winding structure of a chemical fiber cord(s) extending substantially in the circumferential direction is arranged on outer circumferential side of the belt. Particularly, the annular depression is sufficiently restrained by the belt reinforcing layer, whereby the function of the annular depression can be surely guaranteed over a long time. And also, a high-speed durability, steering stability and the like can be enhanced by covering substantially the whole of the belt with the belt reinforcing layer.

On the other hand, it is preferable that the circumferential groove is not arranged on the tread portion within a range of 30-70% of a tread half width from a tread center for preventing a buckling at section in the widthwise direction of the tread in the puncture of the tire or the like, or for preventing a floating phenomenon of a central part in the widthwise direction of the tread portion from the ground contact region to ensure a sufficient ground contacting area. However, if the drainage performance during the normal running of the tire is lacking only by the circumferential grooves, it is preferable to arrange a circumferential sub-groove having a groove width of 0.5-5 mm, preferably not more than 3 mm within the above range.

That is, when the flexural deformation amount of the sidewall portion is increased under the action of the side reinforcing rubber layer in the puncture of the tire or the like and the tread portion is subjected to compression force directing to a central portion side in the widthwise direction accompanied therewith to cause a buckling tendency of floating up the central portion from the ground contact region, if a relatively wide-width circumferential sub-groove is existent within the range of 30-70% of the tread half width from the tread center, it is apt to easily cause a buckling accompanied with violent folding of the tread portion bordering the circumferential sub-groove, and also the folded portion itself easily forms a nucleus of fatigue breakage in the tread portion and further it is high in the fear that the ground contacting area of a tread shoulder portion becomes very small by a large floating of a tread side region resulted from the occurrence of the violent folding. On the contrary, when the circumferential sub-groove having a fine width of about 0.5-5 mm is arranged within the above range, it is an advantage that opposed groove walls of the sub-groove are contacted with each other by compression force acting to the tread portion to produce a drag against the floating of the tread portion and hence the occurrence of the buckling itself is effectively suppressed, and even if the buckling occurs, the floating gradient of the treading region of the tread from the road surface becomes small and hence a larger contacting area can be ensured.

### BRIEF DESCRIPTION OF THE DRAWINGS

FIG. 1 is a diagrammatically section view of the conventional tire in a widthwise direction.

FIG. 2 is a diagrammatically section view of an embodiment of the tire according to the invention in the widthwise direction.

FIG. 3 is a diagrammatically section view of another embodiment of the tire according to the invention in the widthwise direction.

FIG. 4 is a diagrammatically section view of the other embodiment of the tire according to the invention in the widthwise direction.

FIG. 5 is a schematically section view illustrating an occurrence of buckling in a widthwise direction of a tread portion.

FIG. 6 is a schematically section view illustrating an example tire and a comparative tire.

### BEST MODE FOR CARRYING OUT THE INVENTION

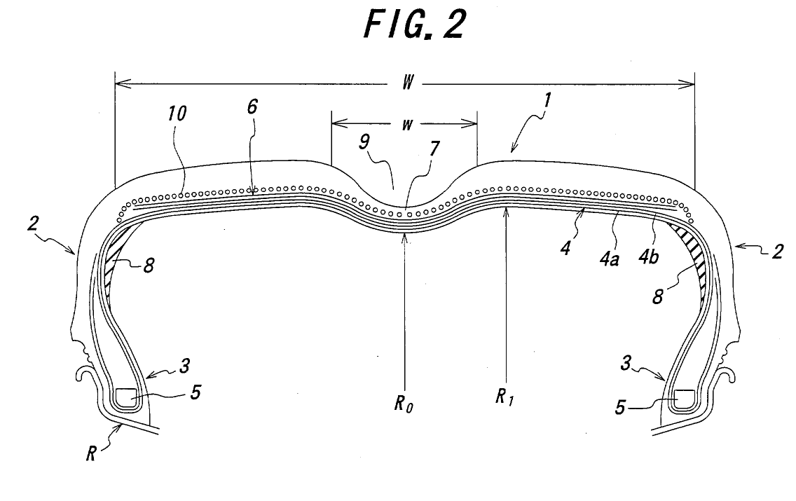

In FIG. 2 is sectionally shown an embodiment of the tire according to the invention under a posture of assembling onto a standard rim and filling an internal pressure of 50 kPa, wherein numeral 1 is a tread portion, numeral 2 a pair of sidewall portions continuously extending inward from the respective side parts of the tread portion 1 in a radial direction, numeral 3 a bead portion continuing to an inner circumferential side of the respective sidewall portion 2.

In this case, a carcass 4 comprised of two carcass plies 4a, 4b is toroidally extended between bead cores 5 embedded in the bead portions 3, and each side portion of the carcass plies 4a, 4b is turned up around the bead core 5, while a belt 6 comprised of two belt layers, cords of which belt layers such as steel cords being crossed with each other, is arranged between a crown portion of the carcass 4 and the tread portion 1.

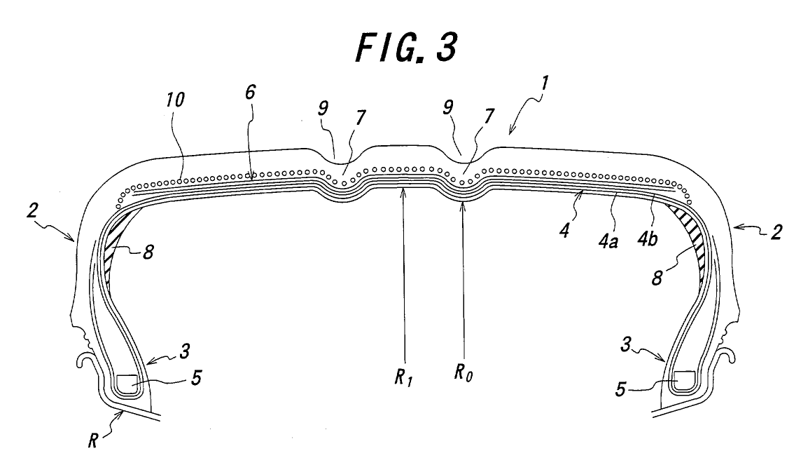

In the illustrated embodiment, one annular depression 7 convexly protruding inward in the radial direction and continuously extending in the circumferential direction is arranged on a widthwise central portion of the belt 6. Moreover, a plurality of annular depressions 7 may be, of course, formed symmetrically with respect to a widthwise center line of the belt 6 or an equatorial plane of the tire as shown in FIG. 3. Even in one or plural depressions, it is preferable to form such annular depression(s) 7 on the central region of the belt in the widthwise direction in connection with an embodiment of forming a circumferential main groove as mentioned later in order to ensure an excellent drainage performance.

And also, a side reinforcing rubber layer 8 having substantially a crescent shape at section is arranged on the sidewall portion 2. The side reinforcing rubber layer 8 is arranged inside an innerliner rubber layer as shown in the figure, or may be arranged outside the innerliner rubber layer or in adjacent to an outside of one or more carcass plies.

It is preferable that a maximum thickness of the side reinforcing rubber layer 8 is within a range of 2-12 mm.

Further, a circumferential main groove 9 continuously extending in the circumferential direction is arranged on the tread portion 1 at a position corresponding to the annular depression 7. According to this structure, the drainage performance can be improved owing to the presence of the circumferential main groove 9. And also, the circumferential main groove 9 is positioned in correspondence to the annular depression 7, whereby sufficiently large groove width and groove depth can easily be ensured. In this case, it is preferable that a total groove width w of one or more circumferential main grooves 9 is not less than 10% of a treading width W of the tread.

More preferably, when the tire is assembled onto a standard rim R and inflated under an internal pressure of 50 kPa as shown in the figure, a radius of R₀ of an inner circumferential face of the annular depression in the belt is made smaller by 5 mm or more than a maximum radius R₁ of an inner circumferential face of the belt 6 to further enhance the reinforcing function of the annular depression 7. Also, it is preferable that a belt reinforcing layer 10 having a spiral winding structure of a chemical fiber cord(s) extending substantially in the circumferential direction is arranged on an outer circumferential side of the belt 6 so as to cover at least the annular depression 7, whereby it is possible to surely develop the function and also the improvement of the high-speed durability is attained.

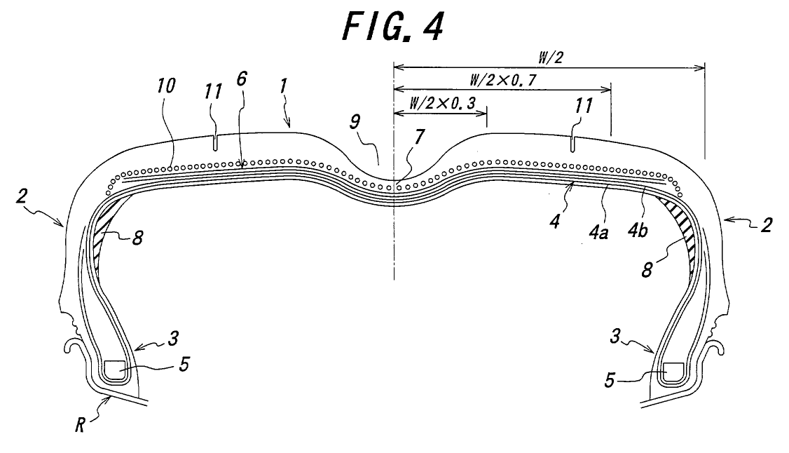

If the given drainage performance can not be ensured only by the one circumferential main groove 9 as shown in FIG. 2, it is preferable that, as shown in FIG. 4, one or more circumferential sub-grooves 11 extending straightforward or zigzag in the circumferential direction at a width of 0.5-5 mm, one circumferential sub-groove 11 in the illustrated embodiment is arranged on substantially a central region of a half of the tread portion, or within a range of 30-70% of a tread half width from a tread center to thereby increase a negative ratio in the tread portion 1.

In this case, the groove width of the circumferential sub-groove is rendered into a range of 0.5-5 mm for suppressing the buckling phenomenon that the widthwise central part of the tread portion 1 floats up from a road surface in the disappear of an internal tire pressure due to the puncture of the tire or the like and ensuring a larger ground contacting area in the widthwise direction of the tread.

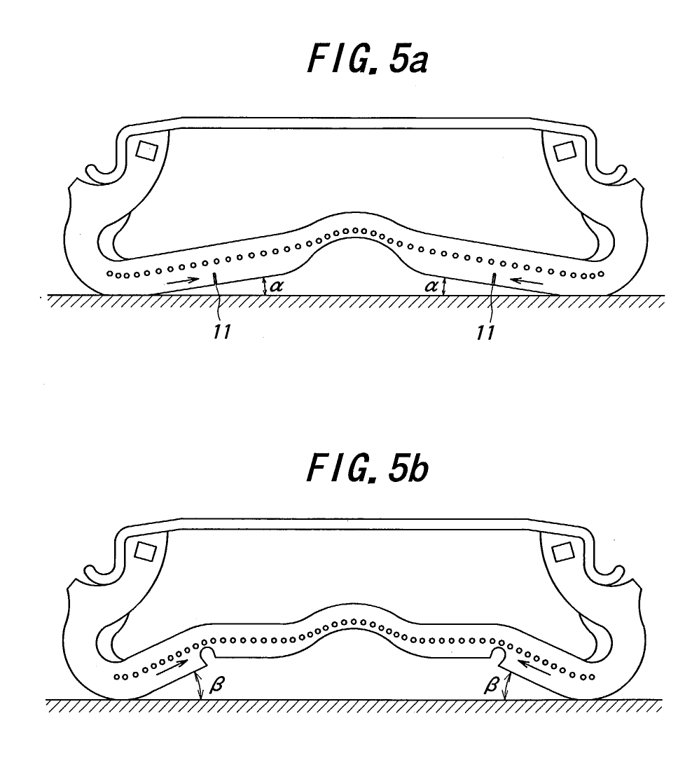

In other words, even if the buckling is caused due to the disappear of the internal tire pressure as exaggeratedly shown in FIG. 5, the circumferential sub-groove 11 having a narrow groove width of 0.5-5 mm is substantially closed by an action of compression force directing to a central part side of the tread portion 1 as shown in FIG. 5a and hence a drag against the buckling is generated to control an amount of floating the tread portion 1 from the road surface and an inclination angle α of a side region of the tread portion with respect to the road surface to small level, whereby a relatively large ground contacting area in the tread shoulder portion can be ensured. On the other hand, when the groove width of the circumferential sub-groove is wider exceeding 5 mm, as shown in FIG. 5b, the bending deformation of the tread portion is produced at a position of the wide-width sub-groove by the similar compression force generated in the tread portion and hence the inclination angle β of the side region of the tread with respect to the road surface becomes large and the ground contacting area of the tread shoulder portion becomes small, and also a fear of manifesting a disadvantage in view of the steering stability and the durability becomes high because it is obliged to cause a premature fatigue of the bending deformed portion during the running of the tire under loading.

### EXAMPLES

### Example 1

With respect to an example tire 1 having a structure shown in FIG. 2 and a maximum thickness of a side reinforcing rubber layer of 5 mm and a tire size of 245/40ZR17 are measured the run-flat durability, weight, ride comfort, resistance to hydroplaning and wear resistance to obtain results as shown in Table 1.

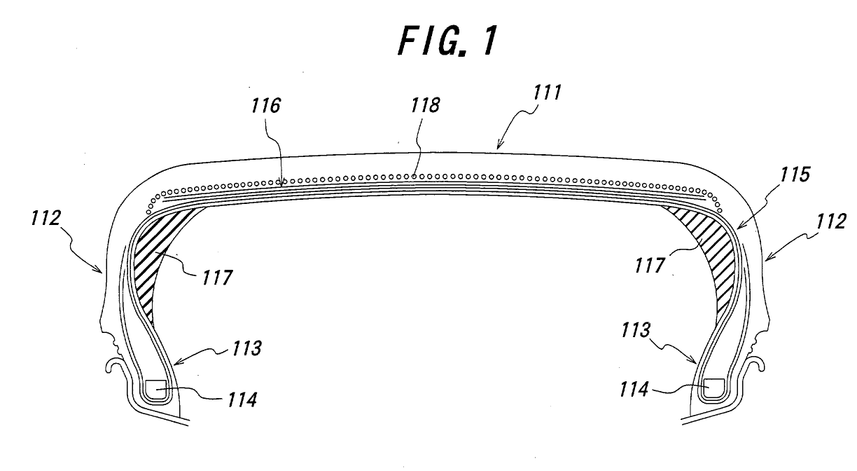

Moreover, conventional tires 1 and 2 in this table have the structure shown in FIG. 1 and the same tire size as described above, wherein the maximum thickness of the side reinforcing rubber layer is 10 mm and 5 mm, respectively.

And also, the evaluation is conducted by showing the measured value of the conventional tire 1 as a control.

Now, the run-flat durability is determined by assembling a test tire onto a rim of 8.5J×17, feeding an internal pressure to fit onto the rim, removing a valve core to render an internal tire pressure into an atmospheric pressure, mounting onto a right rear wheel of a vehicle (air pressure specified by the vehicle in tires mounted on the remaining three wheels), and running at a speed of 80 km/h under a load corresponding to total weight of two crewmen to measure a running distance until the side reinforcing rubber layer of the test tire is broken to detect occurrence of abnormal sound and occurrence of abnormal vibration.

Also, the ride comfort during running on good road and bad road at a state of filling an air pressure specified by the vehicle is determined by scoring every 0.5 point at full points of 10 by a professional driver in an actual running test. The resistance to hydroplaning is determined by a magnification of lateral acceleration speed when a speed is increased from 50 km/h every 5 km/h on a test course having a water depth of 6 mm and a radius of 100 m.

The wear resistance is determined by measuring a worn amount of a tread rubber after the test tire is actually run over 20000 km.

TABLE 1

| | Run-flat | | Ride | Resistance to | Wear |
|---|---|---|---|---|---|
| | durability | Weight | comfort | hydroplaning | resistance |
| Conventional | 100 | 100 | 100 | 100 | 100 |
| tire 1 | | | | | |
| Example | ≧100 | weight | 1 rank up | 1 rank up | improvement |
| tire 1 | | reduction of | | | of 10-20% |
| | | 10-20% | | | |
| Conventional | 30 | weight | 1 rank up | 100 | 100 |
| tire 2 | | reduction of | | | |
| | | 10-20% | | | |

As seen from Table 1, the example tire 1 is superior to the conventional tires in all of the performances.

### Example 2

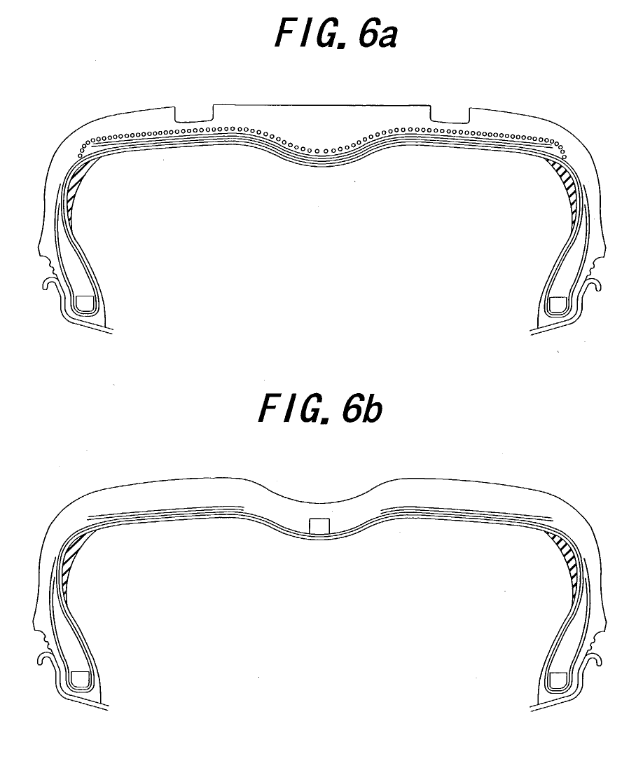

With respect to each of example tires 2 and 3 having the same tire size and structure as in the example tire 1 and example tire 4 having the same size and a structure of circumferential main groove as shown in FIG. 6a are measured the run-flat durability, weight, ride comfort and wet performance to obtain results as shown in Table 2.

A conventional tire 3 in this table has a structure shown in FIG. 1, and a comparative tire has a structure that a bead ring is arranged in a central part on a crown region of a carcass and belt layers are arranged on both side portions of the bead ring.

The run-flat durability and ride comfort are determined in the same manner as described above, and the wet performance is determined by measuring a stopping distance in the braking from a speed of 50 km/h on an asphalt road surface having a water depth of 3 mm and evaluated as a reciprocate of a ratio of the distance when the conventional example is 100.

Moreover, the larger the index value in the performances of the table other than the weight, the better the result.

TABLE 2

| | Conventional | Example | Example | Example | Comparative |
|---|---|---|---|---|---|
| | tire 3 | tire 2 | tire 3 | tire 4 | tire |
| Maximum thickness of | 7 (mm) | 7 (mm) | 4 (mm) | 7 (mm) | 7 (mm) |
| side reinforcing | | | | | |
| rubber layer | | | | | |
| Negative ratio (index) | 100 | 120 | 120 | 100 | 100 |
| Run-flat durability | 100 | 150 | 100 | 140 | 160 |
| Weight (index) | 100 | 100 | 90 | 105 | 120 |
| Ride comfort (index) | 100 | 110 | 130 | 107 | 70 |
| Wet performance (index) | 100 | 110 | 110 | 100 | 105 |

As seen from the above table, all of the example tires 2-4 control the tire weight to a sufficiently small level and can develop an excellent run-flat durability without degrading the ride comfort.

### INDUSTRIAL APPLICABILITY

As seen from the above, the pneumatic safety tire according to the invention can easily be produced without requiring special working steps and increasing the weight, and also the sufficient running durability can be developed during the running under loading in the disappear of the internal tire pressure and the excellent durability, steering stability and ride comfort can be attained during the normal running of the tire under loading and further there is no fear of damaging the degree of true circle in the tire.

1. A pneumatic safety tire comprising a tread portion, a sidewall portion extending inward from each side part of the tread portion in a radial direction, a bead portion continuously arranged at a radially inner end of the sidewall portion, a carcass toroidally extending between the pair of bead portions and frequently wound around a bead core embedded in the respective bead portion from an inside toward an outside, and a belt disposed between a crown portion of the carcass and the tread portion, in which a side reinforcing rubber layer having substantially a crescent form at a section in a widthwise direction is mainly arranged on the sidewall portion and at least one annular depression convexly protruding inward in the radial direction and continuously extending in the circumferential direction is arranged on the belt.

2. A pneumatic safety tire according to claim 1, wherein the annular depression(s) is arranged symmetrically with respect to a center line in a widthwise direction of the belt.

3. A pneumatic safety tire according to claim 1 or 2, wherein the annular depression is arranged on a widthwise central part of the belt.

4. A pneumatic safety tire according to any one of claims 1-3, wherein the side reinforcing rubber layer has a maximum thickness of 2-12 mm.

5. A pneumatic safety tire according to any one of claims 1-4, wherein a circumferential main groove(s) is arranged on the tread portion at a position corresponding to the annular depression(s).

6. A pneumatic safety tire according to claim 5, wherein a total width of the circumferential main groove(s) is not less than 10% of a treading width of the tread.

7. A pneumatic safety tire according to any one of claims 1-6, wherein a radius of an inner circumferential face of the annular depression in the belt at a posture of assembling onto a standard rim and filling an internal pressure of 50 kPa is made smaller than a maximum radius of an inner circumferential face of the belt.

8. A pneumatic safety tire according to any one of claims 1-7, wherein a belt reinforcing layer having a spiral winding structure of a cord extending substantially in the circumferential direction is arranged on an outer circumferential side of the belt.

9. A pneumatic safety tire according to any one of claims 1-8, wherein a circumferential sub-groove is arranged on the tread portion at a position corresponding to 30-70% of a tread half width from a tread center with a groove width of 0.5-5 mm.
